(19) United States
(12) Patent Application Publication
(10) Pub. No.: US 2025/0338837 A1
(43) Pub. Date: Nov. 6, 2025

(54) FISHING SKIRT TOOL

(71) Applicant: Graham Grove, Atascadero, CA (US)

(72) Inventor: Graham Grove, Atascadero, CA (US)

(21) Appl. No.: 18/652,799

(22) Filed: May 1, 2024

(51) Int. Cl. A01K 97/28

(52) U.S. Cl. CPC A01K 97/28

(57) ABSTRACT

A fishing skirt tool is disclosed for efficiently joining a skirt material to a fishing jig, enhancing the ease and precision of assembly. The tool comprises a baseplate with a top and bottom surface, featuring a first opening and protrusions with attachment members. Additionally, a primary bracket is rotatably connected to the baseplate, having a jig holder for secure jig placement. During operation, users affix the skirt material to the attachment members, securing the fishing jig to the fishing skirt tool. This arrangement enables users to freely position the jig relative to the skirt material while having both hands available for tying. The fishing skirt tool streamlines the process of attaching the skirt material to the fishing jig, offering convenience and efficiency to fishing enthusiasts.

### BACKGROUND

In the realm of angling, fishing jigs equipped with skirts have long been a common lure among fishermen for their effectiveness in attracting fish to bite. Skirts, typically made of silicone or rubber strands, add flair and mimic the appearance of baitfish or other prey, thereby enticing predatory fish species. The strategic placement of skirts on fishing jigs allows anglers to manipulate the movement and presentation of the lure, enhancing its appeal to target species. Moreover, skirts provide a means of customizing the lure's appearance, catering to various fishing conditions and preferences.

Central to the efficacy of skirts on fishing jigs is how they are affixed to the lure. Proper tying techniques play a crucial role in ensuring the durability and functionality of the skirt attachment. A securely tied skirt not only withstands the rigors of casting and retrieval but also maintains its lifelike movement underwater, maximizing its allure to fish. Moreover, a well-tied skirt minimizes the risk of premature detachment, safeguarding against the loss of the lure and potential environmental impact.

While there are various methods for securing skirts to fishing jigs, employing wire, thread, or string for attachment offers distinct advantages over alternative approaches such as elastic bands. Wire provides superior strength and resilience, effectively anchoring the skirt material to the fishing jig and reducing the likelihood of slippage or displacement during use. Unlike elastic bands, which may degrade over time or succumb to wear and tear, wire ensures a secure and long-lasting connection between the skirt and the jig, thereby prolonging the lure's effectiveness and lifespan. Additionally, the use of wire affords anglers greater control over the positioning and arrangement of the skirt strands, allowing for precise adjustments to optimize the lure's performance in different fishing scenarios. In summary, tying a skirt material to a fishing jig with wire represents a pragmatic and advantageous approach, bolstering both the functionality and durability of the lure while enhancing its appeal to target fish species.

### SUMMARY

It is desirable, therefore, to have a skirt material tied to a jig as tight as possible to increase the flare of the skirt material and decrease the likelihood of skirt material becoming disjoined from the jig. The present invention allows for the skirt material to be secured between a first protrusion and a second protrusion, and a jig holder also secures the jig to the fishing skirt tool. This allows for a user to move both hands freely around the jig and through a first opening of a baseplate. This free movement enables proper adjoining by allowing for space for the user to apply tension to a wire, tie a knot, organize the skirt material, or cut the wire.

Another object of the present invention is to allow the user of the fishing skirt tool to assembly different combinations of types or colors of skirt material with ease upon the baseplate before tying the fishing jig,

In order to do so, a fishing skirt tool is provided for adjoining a skirt material to a fishing jig. By securing the fishing jig to the fishing skirt tool a user can freely position the fishing jig relative to the skirt material and have both hands free to tie a wire around the skirt material and the jig. During operation, a baseplate is adjoined or secured to a surface and has a first protrusion and a second protrusion. On a portion of the baseplate, a first opening extends through the baseplate allowing space for the user to move the wire around the fishing jig and the skirt material. Extending outward form, the baseplate is a first protrusion extending outward having a first attachment member and a second protrusion having a second attachment member. During operation, the user temporarily adjoins the skirt material to the first attachment member and the second attachment member. Next, to secure the jig during assembly of the fishing jig a primary bracket is rotatably adjoined to the baseplate. A jig holder adjoined to the primary bracket and holds the fishing jig during assembly.

### BRIEF DESCRIPTION OF THE FIGURES

The detailed description of some embodiments of the invention is made below with reference to the accompanying figures, wherein like numerals represent corresponding parts of the figures.

FIG. 1 shows an exemplary perspective view of one embodiment of the fishing skirt tool.

FIG. 2A shows an exemplary front view of one embodiment of the fishing skirt tool.

FIG. 2B shows an exemplary front view of one embodiment of the fishing skirt tool.

FIG. 2C shows an exemplary front view one embodiment of the fishing skirt tool.

FIG. 3 shows an exemplary perspective view of one embodiment of the fishing skirt tool.

FIG. 4 shows an exemplary top view of one embodiment of the fishing skirt tool.

FIG. 5 shows an exemplary exploded view of one embodiment of the fishing skirt tool.

FIG. 6 shows an exemplary front view of one embodiment of the fishing skirt tool.

FIG. 7 shows an exemplary front view of one embodiment of the fishing skirt tool.

FIG. 8 shows an exemplary rear of one embodiment of the fishing skirt tool.

FIG. 9 shows an exemplary bottom view of one embodiment of the fishing skirt tool.

FIG. 10 shows an exemplary top view of one embodiment of the fishing skirt tool.

FIG. 11 shows an exemplary left view of one embodiment of the fishing skirt tool.

FIG. 12 shows an exemplary right view of one embodiment of the fishing skirt tool.

### DETAILED DESCRIPTION OF CERTAIN EMBODIMENTS

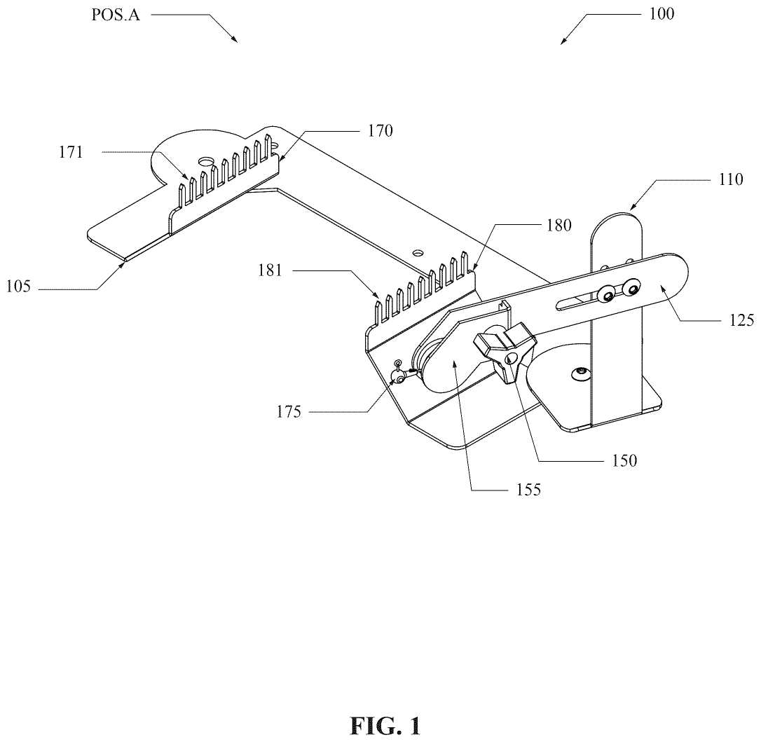

In regard to the current invention, FIG.1 shows an exemplary embodiment of a fishing skirt tool 100 for operation by a user to adjoin a skirt material 115 to a jig 175. During exemplary operation, a user may secure a baseplate 105 to a surface such as a table or a workbench, to keep the baseplate 105 from moving. At least one baseplate hole 200 may extend through the baseplate 105 to allow for mounting with a fastener or a screw to the surface. Those skilled in the art will recognize many suitable ways to secure the baseplate to the surface, such as a table clamp (not shown) or an adhesive. Extending outward the baseplate 105 a first protrusion 179 and a second protrusion 180 are positioned near a first opening 210. In some embodiments, the first protrusion 170 or the second protrusion 180 may not extend from the baseplate 105 and may be co-planar to a top surface or a bottom surface of the baseplate 105. Adjoined to the first protrusion 170 and the second protrusion 180 are a first attachment member 171 and a second attachment member 181, respectively.

During exemplary operation, the user secures the skirt material 115 to the first attachment member 171 and a second attachment member 181. Commonly the skirt material 115 is comprised of a silicone or rubber material and commercially available in strands adjoined together. Opposing ends of the skirt material 115 are adjoined to the first attachment member 171 and a second attachment member 181. In the present embodiment as shown in FIG. 1, the first attachment member 171 and a second attachment member 181 are shown as a plurality of spikes to be positioned between the strands of the skirt material 115. The first opening 210 and/or the spacing between the first protrusion 170 and the second protrusion 180, in some embodiments, may be sized to match the commercially available length of the desired skirt material 115 desired by the user. In other embodiments, the fishing skirt tool 100 may not comprise the first protrusion 170 and the second protrusion 180 and only comprise the first attachment member 171 and a second attachment member 181.

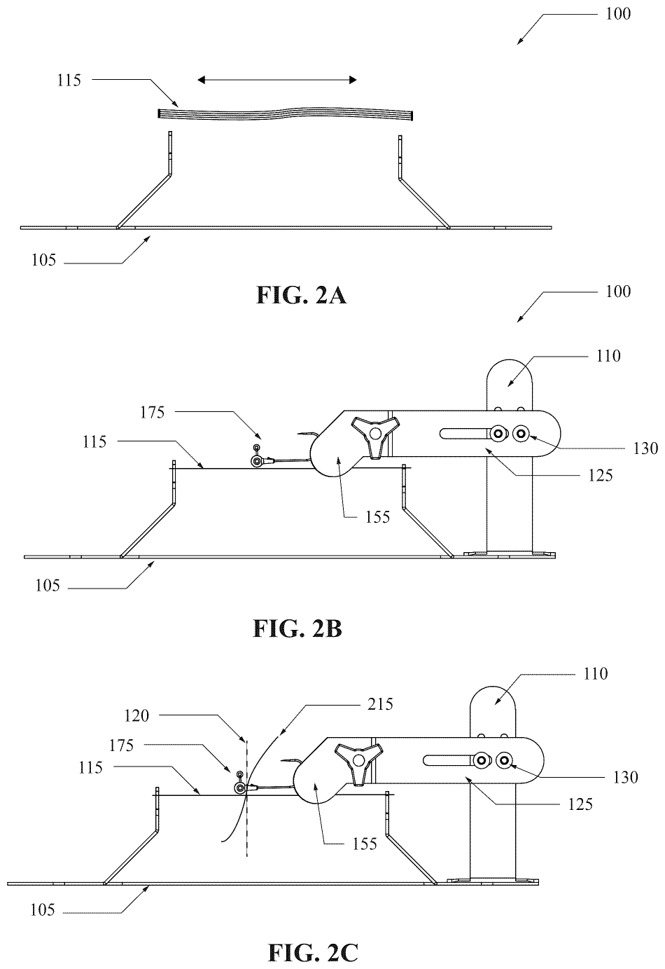

In the present embodiment shown in FIGS. 2A,2B and 2C the first protrusion 170 and the second protrusion 180 extends about 45 degrees outward from the top surface of the baseplate 105. During exemplary operation, the skirt material 115 is stretched or placed over both the first protrusion 170 and the second protrusion 180 as shown in FIG. 2A. Next, a user may secure a jig 175 to a primary bracket 110 by means of a jig bracket 155. In the present embodiment, a secondary bracket 125 is shown positioned between the primary bracket 110 and the jig bracket 155. The primary bracket 110 is shown to be rotatably adjoined to the baseplate 105 by a primary bracket fastener 131. The primary bracket fastener 131 provides a center of rotation for the primary bracket 110 relative to the baseplate 105. The rotation of the primary bracket 110 allowing therein for the user unobscured access to the first protrusion 170 and the second protrusion 180 when placing the skirt material 115 onto the fishing skit tool 100. In other embodiments, the jig bracket 155 may be directly adjoined to the primary bracket 110. In FIG. 2C, a wire 215 is shown that is wrapped by the user along a first plane 120. The wire 215 surrounding the jig 175 and the skirt material 115 to tie or secure the skirt material 115 to the jig 175. In some embodiments, it is desirable to adjust the position of the jig bracket 155 to the skirt material 115 held by the fishing tool 100. In order to provide this adjustment, the jig bracket 155 or the secondary bracket 125 may be adjoined to the primary bracket 110 by a secondary bracket fastener 130. The primary bracket 110 may further comprise a primary slot 136 to allow for further adjustment of the fishing skirt tool 100. In the present embodiments, the secondary bracket 125 further comprises a secondary slot 135 to allow for further adjustment of the fishing skirt tool 100. In some embodiments, the secondary slot 135 or the primary slot 136 may comprise at least one elongated slot or at least one threaded opening to accept the secondary bracket fastener 130.

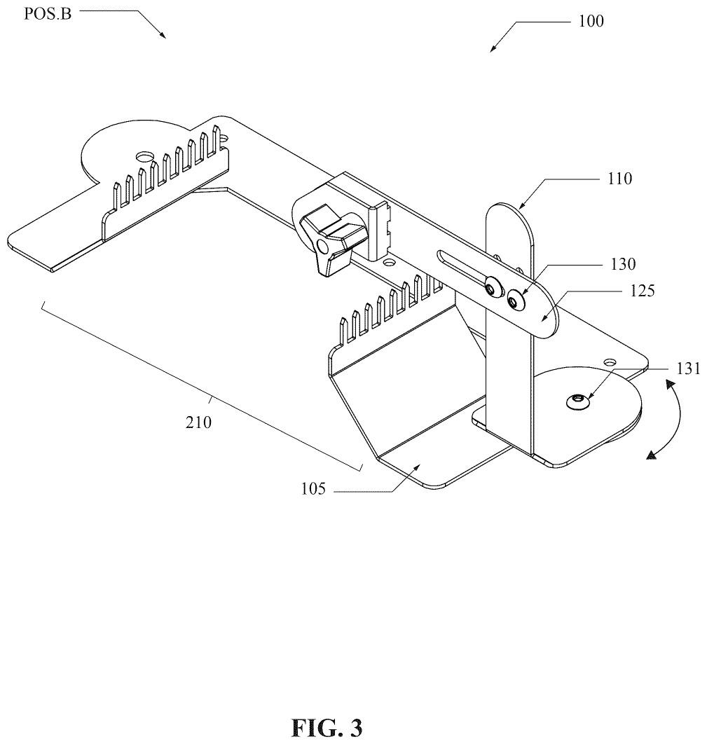

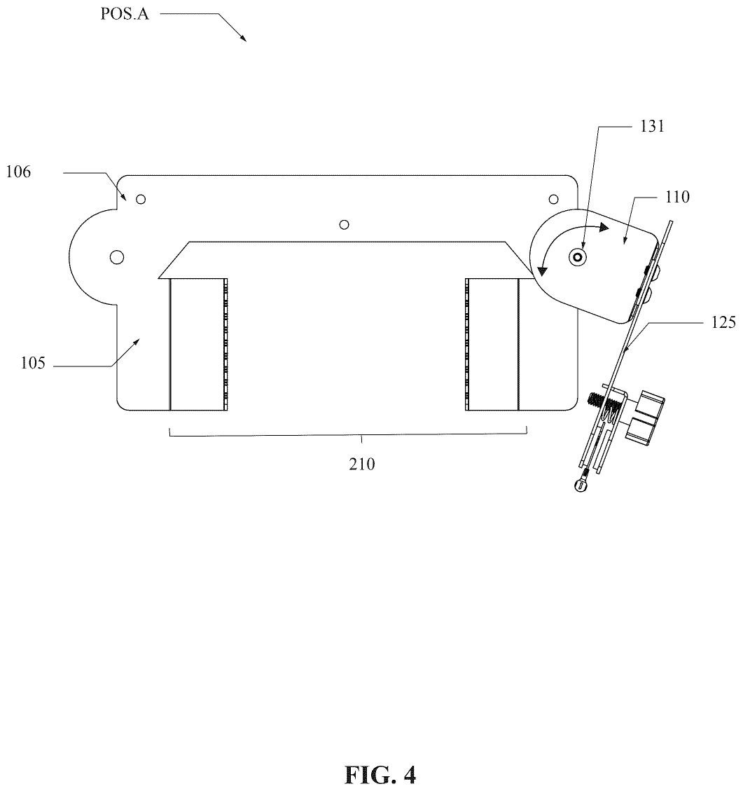

As shown in FIG. 3 and FIG. 4, the fishing skirt tool 100 is shown in a closed position POS.B. In FIG. 1, the fishing skirt tool 100 is shown in an open position POS.A. During exemplary operation, the user may rotatably move the primary bracket 110 relative to the baseplate 105, thereby moving the jig 175 near or away from the skirt material 115. During exemplary operation, the user may rotatably move the primary bracket 110 relative to the baseplate 105, thereby moving the fishing skirt tool 100 to and from the open position POS.A and the closed position POS.B. In the present embodiment, the primary bracket 155 is shown on a right side of the baseplate 105. In other embodiments, the primary bracket 105 may be positioned on a left side of the baseplate 105 as desired by the user or needed by the user based on their dexterity.

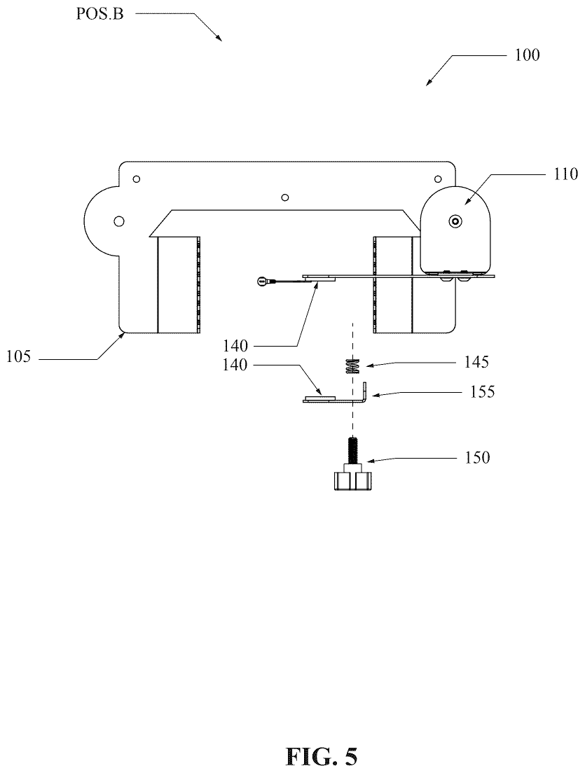

As shown in FIG. 5, the current embodiment of the fishing skit tool 100 is shown in an exploded view. In the current exemplary embodiment, the jig bracket 155 is secured to the secondary bracket 126 by a spring-biased knob 150. A spring 145 is positioned around the spring-biased knob 150 and between the secondary bracket 125 and the jig bracket 155. A rubber member 140 is shown on the jig bracket 155 and the secondary bracket 125. The rubber member 140 contacts the jig 175 during the process of securing the jig 175 to the fishing skirt tool 100. During operation, the user turns the spring biased knob to adjust the clamping of the jig 175 to the fishing skirt tool 100. In some embodiments, the fishing skirt tool 100, may be made from at least one member of a material set consisting of: a metal, a composite, a rubber, a plastic, a wood, a foam, a fabric, or any combination thereof.

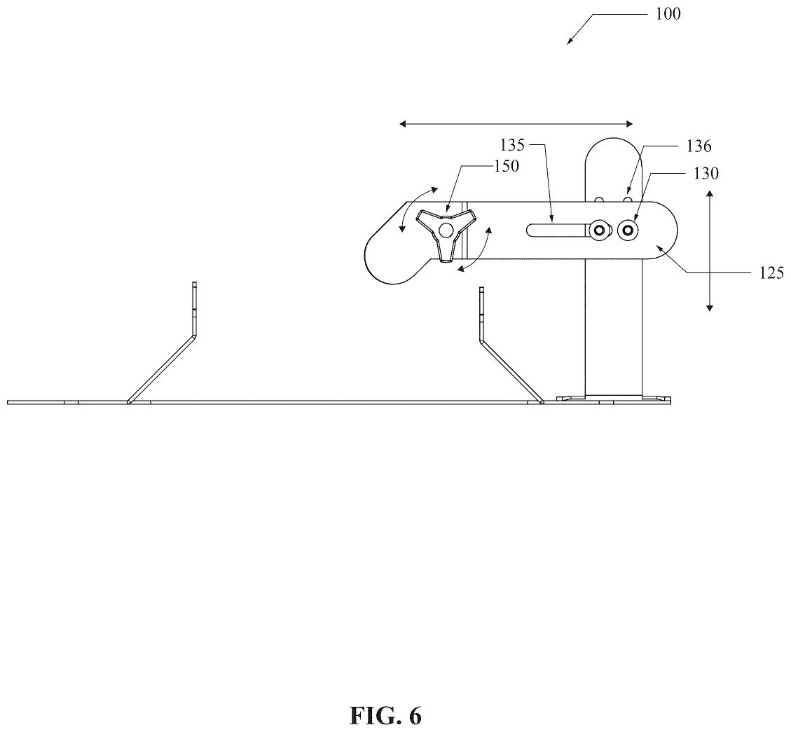

As shown in FIG. 6, the current embodiment comprises the secondary bracket 125 that may be positioned by the user left, right, up, or down relative to the skirt material 115 as desired by the user. In other embodiments, the primary bracket 110 may be positioned by the user left, right, up, or down relative to the skirt material 115 as desired by the user.

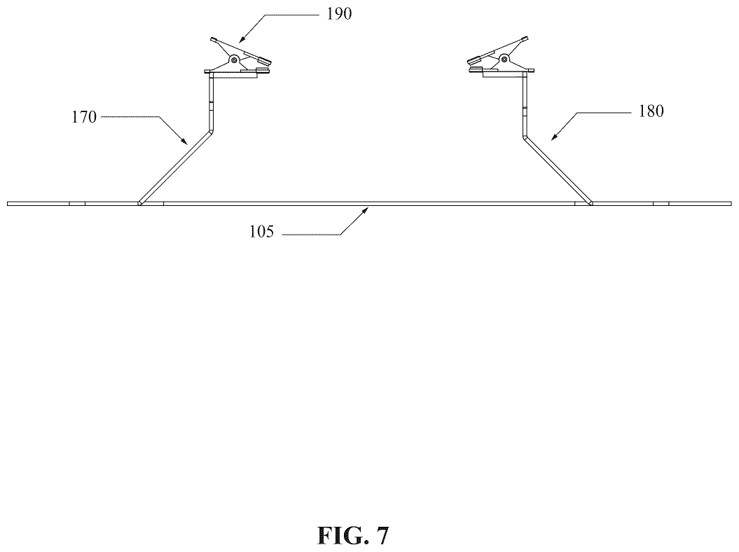

As shown in FIG. 7, in other exemplary embodiments, the jig bracket 155, the rubber member 140, the first attachment member 171 or the second attachment member 181 may comprise at least one member of an attachment set consisting of: a magnet, a clamp 190, an adhesive, a heat shrink material, a Velcro material, a slot, a putty, a fastener, a spring or any combination thereof to secure the jig 175 or the skirt material 115 to the fishing skirt tool 100.

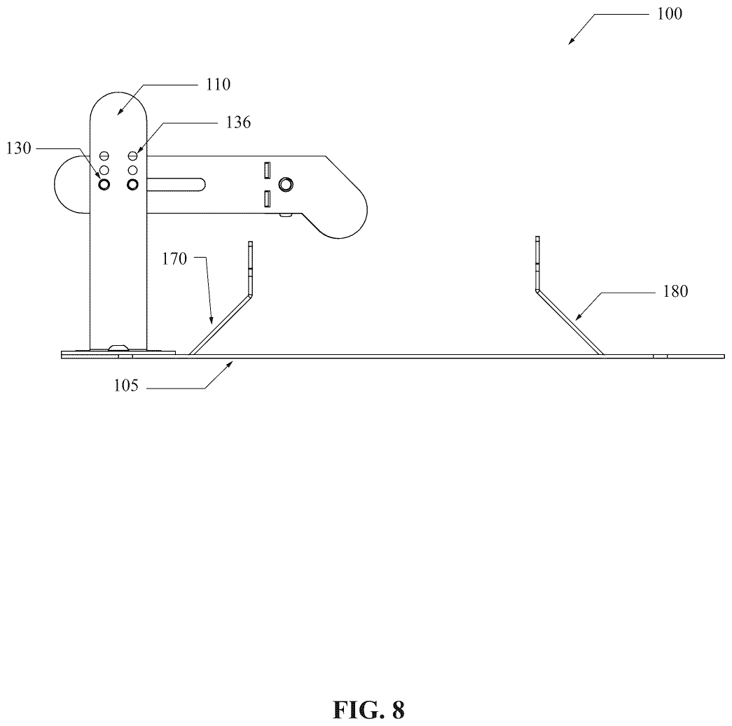

In the current embodiment, shown in FIG. 8, the secondary bracket 125 is secured to the primary bracket 110 by the secondary bracket fastener 130 through the secondary slot 135 and the primary slot 136. The current embodiment shows the secondary slot 135 as an elongated slot and the primary slot as a series of small threaded openings, but without limitation, the secondary slot 135 and the primary slot 136 may be any shape to allow for adjustment of the secondary bracket 125 relative to the primary bracket 110.

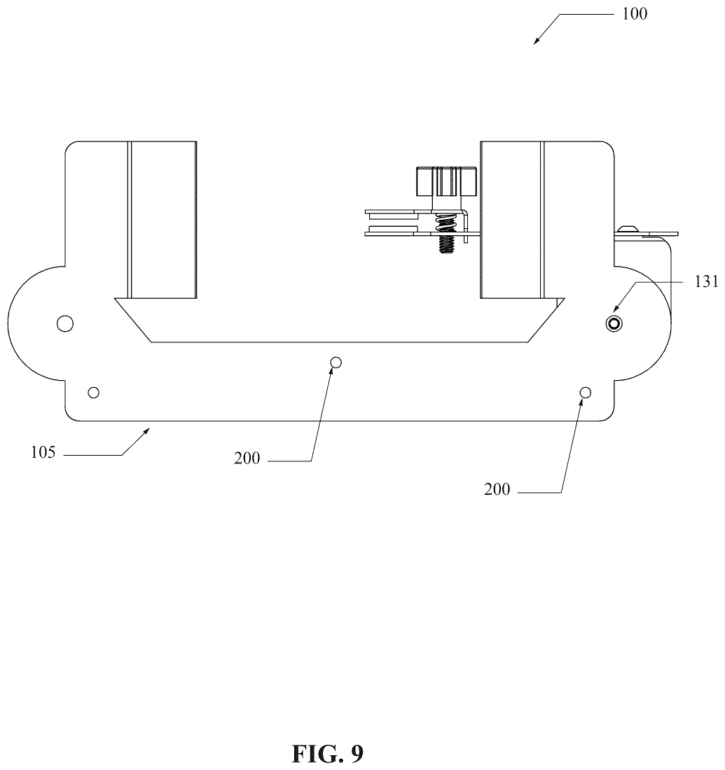

As shown in FIG. 9, the primary bracket fastener 131 is shown extending through the baseplate 105 to secure the primary bracket 110 to the baseplate 105. The at least one baseplate hole 200 is shown extending through the baseplate 105 to allow for place of a fastener or a screw through the baseplate 105 for semi-permanent mounting to a surface.

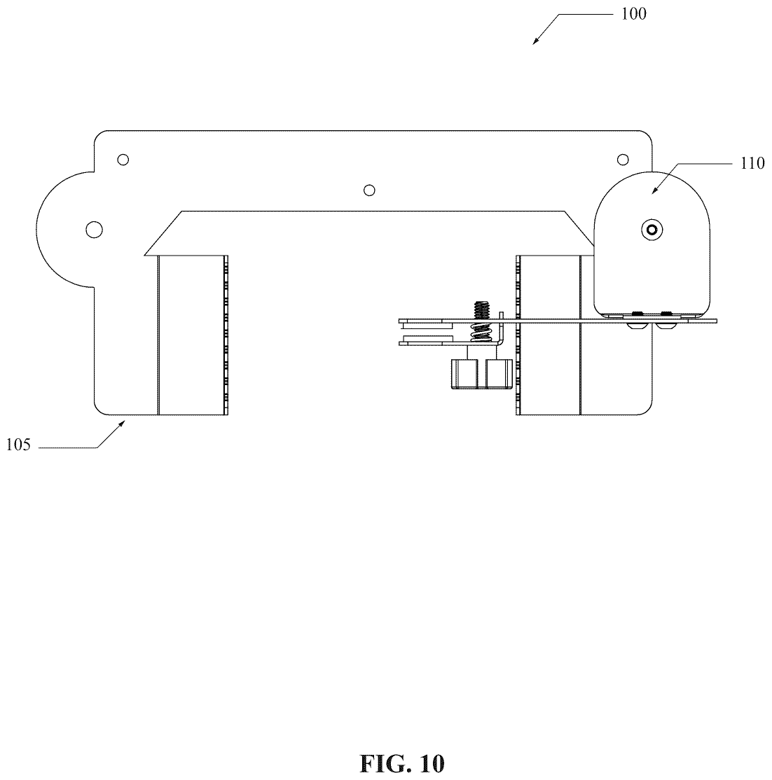

FIGS. 10,11 and 12 show the fishing skirt tool in the closed position POS.B. without the jig 175 or the skirt material 115 shown. The spring-biased knob 150 is shown to extend through the jig bracket 155 and the secondary bracket 125.

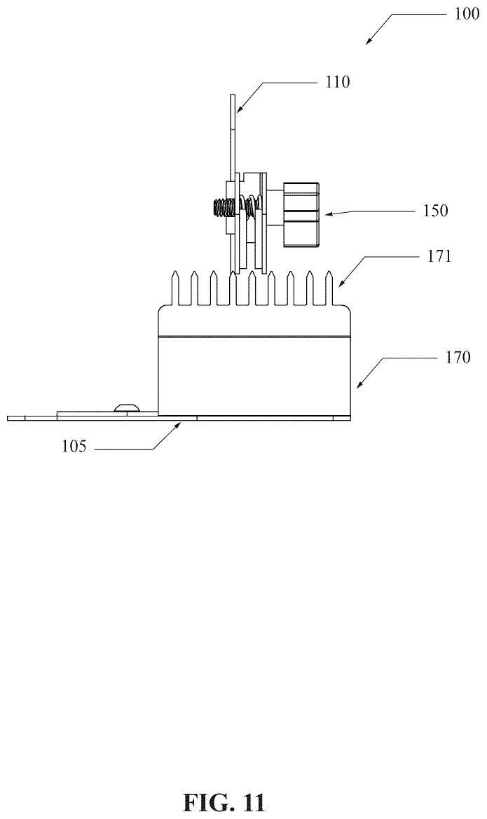

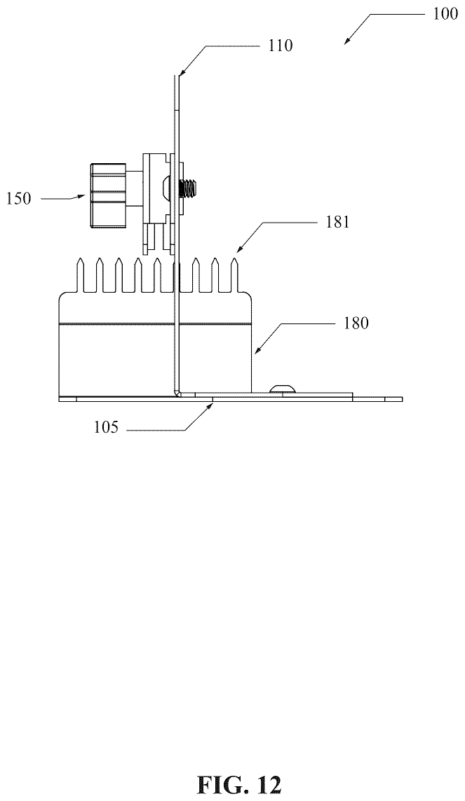

In reference to FIGS. 1 through 12, the present invention may include the following elements:
a fishing skirt tool 100
a baseplate 105
at least one baseplate hole 106
a primary bracket 110
a skirt material 115
a first plane 120
a secondary bracket 125
a secondary bracket fastener 130
a primary bracket fastener 131
a secondary slot 135
a primary slot 136
a rubber member 140
a spring 145
a spring-biased knob 150
a jig bracket 155
a first protrusion 170
a first attachment member 171
a jig 175
a second protrusion 180
a second attachment member 181
a clamp 190
a baseplate hole 200
a first opening 210
a wire 215
an open position POS.A
a closed position POS.B

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, ¶ 6. In particular, any use of “step of” in the claims is not intended to invoke the provision of 35 U.S.C. § 112, ¶6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A fishing skirt tool for adjoining a skirt material to a fishing jig, comprising:
a baseplate having a top surface and a bottom surface,
a first opening ending through the baseplate;
a first protrusion extending outward from the top surface of the baseplate having a first attachment member,
a second protrusion extending outward from the top surface of the baseplate having a second attachment member,
a primary bracket rotatably adjoined to the baseplate having a proximal end and a distal end;
a jig holder adjoined to the distal end of the primary bracket; and
wherein during operation a user adjoins the skirt material to the fishing jig after securing the skirt material to the first attachment member and the second attachment member and positioning the fishing jig above the skirt material.

2. The fishing skirt tool of claim 1, wherein the first attachment member and the second attachment member comprise a plurality of spikes.

3. The fishing skirt tool of claim 1, wherein the jig holder further comprises a spring-biased knob for rotatably moving a jig bracket relative to the primary bracket.

4. The fishing skirt tool of claim 1, further comprising:
a secondary bracket positioned between the jig holder and the distal end of the primary bracket.

1. ishing skirt tool of claim 1, wherein the first attachment member or the second attachment member comprises at least one member of an attachment set consisting of: a magnet, a clip, a clamp, a spring, a spike, a fastener, an elastic member, and an adhesive.

6. The fishing skirt tool of claim 1, wherein the base plate further comprises at least one baseplate hole extending through to the baseplate to allow for mounting of the base plate to a surface.

7. The fishing skirt tool of claim 1, further comprising:
a table clamp for adjoining the bottom surface of the base plate to a surface.
